(19) United States
(12) Patent Application Publication
(10) Pub. No.: US 2003/0116400 A1
(43) Pub. Date: Jun. 26, 2003

(54) Banknote accumulator

(76) Inventors: Leon Saltsov, Thornhill (CA); Oleksandr Onipchenko, Thornhill (CA); Sergiy Bukhman, Toronto (CA); Sergiy Androsyuk, Thornhill (CA); Mykhaylo Kucherenko, Thornhill (CA)

Correspondence Address: DENNISON ASSOCIATES, 133 RICHMOND STREET WEST, SUITE 301, TORONTO, ON, M5H 2L7, CA

(21) Appl. No.: 10/259,299

(22) Filed: Sep. 30, 2002

(30) Foreign Application Priority Data
Sep. 28, 2001 (CA) 2,357,930

(51) Int. Cl. G06K 7/00; G07D 7/00; G07F 7/04; G06K 9/00

(52) U.S. Cl. 194/207

(57) ABSTRACT

A banknote accumulator receives banknotes on a winding drum interior to a housing through a banknote slot. The housing has a number of unique features including its exterior shape. The accumulator is essentially passive as the operation thereof is controlled by an exterior system but it includes various senses and signal processing to provide information to adjust the operation of the accumulator. In a preferred aspect of the invention, the housing includes transparent panels that allow visual inspection of the interior of the housing. A hinged panel is movable between a closed operative position and an open service position and is held in the closed operative position by a latch.

### FIELD OF THE INVENTION

The present invention relates to banknote accumulators and in particular, relates to an improved banknote accumulator designed to operate within a financial transaction device.

### BACKGROUND OF THE INVENTION

There is a continuing effort to streamline and improve the efficiency of completing a financial transaction involving the exchange of paper currency. These financial transactions include typical bank teller type applications where the bank teller may receive certain banknotes for deposit or receive a request for providing the customer with banknotes, to retail applications regarding the purchase of a product or service to automated non-attended financial transactions such as banking machines, vending machines, and gaming machines. To a great extent, the economy is still based on the exchange of paper currency to complete financial transactions.

Vending machines and gaming machines are two examples where banknote validators have been used to basically receive banknotes from users conduct an examination of the banknote as part of a decision to accept or reject the banknote and to store in a banknote cassette any received banknotes. Depending upon the particular application, these devices can be associated with coin dispensers for providing any change to the user to complete the financial transaction. Devices of this type have also been designed to accept various types of cards, such as credit cards, debit cards, cheque cards, etc. as an alternate form of payment or payout.

In some applications such as automatic teller machines used for banking applications, the device includes a store of preloaded banknotes which are available for dispensing to the user. Such teller machines require frequent service particularly to replenish the supply of banknotes. Although such bank teller machines have been designed to accept deposits, including a deposit of banknotes, such deposits have typically been placed in an envelope and are separately processed and again, require frequent service to remove and allow confirm of the deposits.

Other financial transaction machines have been proposed where banknote accumulators are included and these accumulators capable of receiving and storing banknotes for subsequent transactions. These financial transaction machines include a banknote validator and a processing arrangement to decide whether banknotes received as part of a financial transaction should be temporarily stored in the banknote accumulator and may be available for future dispensing. Such financial transaction machines which are capable of receiving banknotes in banknote accumulators require less service as there is the possibility that received banknotes are effectively recycled. Machines of this type have particular application in vending and gaming applications or other applications where banknotes are being provided to the machine for credit towards a product or service.

One of the problems associated with recycling of banknotes which have already been validated by the device is the wide variance in the quality of banknotes in general circulation. Thus the quality of the banknote being recycled can vary and there have been problems with respect to accumulators becoming jammed or inoperative and as such, not reliable. Unfortunately this increases the downtown of the machine and it also severely reduces the number of appropriate applications as the user basically accepted that the device would function and has inserted certain banknotes into the device. Should there be a problem with the transaction, the device must be capable of returning the inserted banknotes or a service personnel must be available to intervene and provide appropriate compensation to the user.

The present invention provides an improved banknote accumulator which addresses a number of problems described above.

### SUMMARY OF THE INVENTION

A banknote accumulator according to the present invention comprises a housing having a banknote slot through which banknotes are received, and a winding drum within the housing and rotatably drivable for winding of banknotes thereon. Guide tapes are attached to the winding drum and form a transition for guiding a banknote onto or off of the winding drum and through the banknote slot. A drive arrangement rotatably drives the winding drum in a banknote receiving direction to wind a banknote and the tapes about the winding drum and rotatably drives the winding drum in a banknote dispensing direction to dispense a last received banknote on the winding drum with the tapes guiding said last received banknote from the winding drum through the banknote slot. The drive arrangement additional drives the guide tapes to accumulate the guide tapes as the tapes are unwound from the winding drum during dispensing of the last to be received banknote. The housing has at least one transparent observation panel sized to allow visual inspection of the winding drum and the guide tapes through the housing.

According to an aspect of the invention the housing includes end panels and side panels with the side panels being transparent.

According to a further aspect of the invention, the housing includes optical elements which directs light from an optical transmitter towards a banknote for reflection to an optical receiver where the optical transmitter and the optical receiver are on the same side of the banknote.

In an aspect of the invention, the housing is rearwardly angled adjacent the banknote slot and forms a wedged shaped housing configuration centered on the banknote slot.

In a further aspect of the invention, the accumulator includes a speed sensing arrangement for measuring banknote receiving and banknote dispensing speed.

In a preferred aspect of the invention, the accumulator includes a speed sensing arrangement which measures tape speed adjacent the banknote slot.

In yet a further aspect of the invention, the banknote accumulator includes an electrical signal processing arrangement and an electrical signal transmission arrangement through which operational information of the accumulator is transmitted.

In a different aspect of the invention, the banknote accumulator includes a self contained power supply and memory means for recording of sensed changes to the accumulator after removal from a financial transaction device.

In an aspect of the invention, the housing has a releasable panel movable from a closed position defining an operating configuration of said housing to an open service position providing access to the interior of the housing. Preferably, a latch arrangement maintains said releasable panel is said closed position.

The present invention comprises a banknote accumulator according to a housing having a banknote slot through which banknotes are received, a winding drum within the housing and rotatably drivable for winding of banknotes thereon, guide tapes attached to the winding drum and forming a transition for guiding a banknote onto or off of the winding drum and through the banknote slot, a drive arrangement for rotatably driving the winding drum. The drive arrangement drives the winding drum in a banknote receiving direction to wind a banknote and the tapes about the winding drum and rotatably drives the winding drum in a banknote dispensing direction to dispense a last received banknote on the winding drum with the tapes guiding the last received banknote from the winding drum through said banknote slot. The drive arrangement additional drives the guide tapes to accumulate the guide tapes as the tapes are unwound from the winding drum during dispensing of the last to be received banknote. The accumulator includes a plurality of electrical sensors which measure and detect operating conditions of the accumulator and an electrical signal processor for analyzing the signals of the sensors and to communicate with a remote financial transaction processor through an electrical connection associated with the housing and through which power is provided to the accumulator.

In an aspect of the invention, the banknote accumulator includes separate power means and memory means associated with the electrical signal processor for recording of changes to the accumulator when power is not provided thereto through the electrical connection.

In an aspect of the invention, the electrical connection is spring mounted.

In a further aspect of the invention, the accumulator includes electrical sensors for detecting a banknote in said banknote slot and the speed of the banknote in said banknote slot.

In a different aspect of the invention, the electrical signal processor transmits speed information of a banknote being received or being dispensed through the electrical connection which speed information is used to externally adjust the speed of said drive arrangement.

Preferably, the housing includes a transparent panel forming part of a banknote sensing arrangement.

In an aspect of the invention, the transparent panel forms part of a light sensor used to detect the presence of a banknote in the banknote slot. In a further aspect of the invention, the transparent panel is hingedly attached to the accumulator and is movable between a closed position allowing viewing of components interior to the housing and an open position providing access to components interior to the housing.

### BRIEF DESCRIPTION OF THE DRAWINGS

Preferred embodiments of the invention are shown in the drawings, wherein:

FIG. 1A is a side elevation of a financial transaction machine;

FIG. 1 is a perspective view of the banknote accumulator;

FIG. 2 is a partial sectional view showing various components of the banknote accumulator;

FIG. 3 is a partial perspective view showing the interior working components of the banknote accumulator;

FIG. 4 is a side view of the banknote accumulator showing the drive mechanism showing the components of the accumulator;

FIG. 5 is a side view similar to FIG. 4 with the drive operating to dispense a banknote;

FIG. 6 is a partial perspective view showing the banknote entry slot to the accumulator;

FIG. 7 is a partial schematic view showing part of the banknote slot and a sensing arrangement associated therewith;

FIGS. 8 and 9 are partial views of the banknote slot showing the banknote sensing arrangement;

FIG. 10 is a partial perspective view showing a speed measurement arrangement associated with a separating tape of the device;

FIG. 11 is a partial top view showing the taped speed sensing arrangement;

FIG. 12 is a partial end view showing the sensing arrangement in a position indicating the accumulator is full;

FIG. 13 is a view similar to FIG. 12 with the sensing arm indicating that the accumulator can later receive further banknotes;

FIG. 14 is a partial perspective view of the sensing arrangement of FIGS. 12 and 13;

FIG. 14 is a partial perspective view showing the end of the separating tapes which are of a special configuration for simple sensing thereof;

FIG. 15 is a partial end view showing the spring mount of an electrical connector to one side of the banknote accumulator;

FIG. 16 is a view similar to FIG. 15 with the connector in its normal position; and

FIG. 17 is a partial perspective view of the electrical connection of FIGS. 15 and 16.

### DETAILED DESCRIPTION OF THE PREFERRED EMBODIMENTS

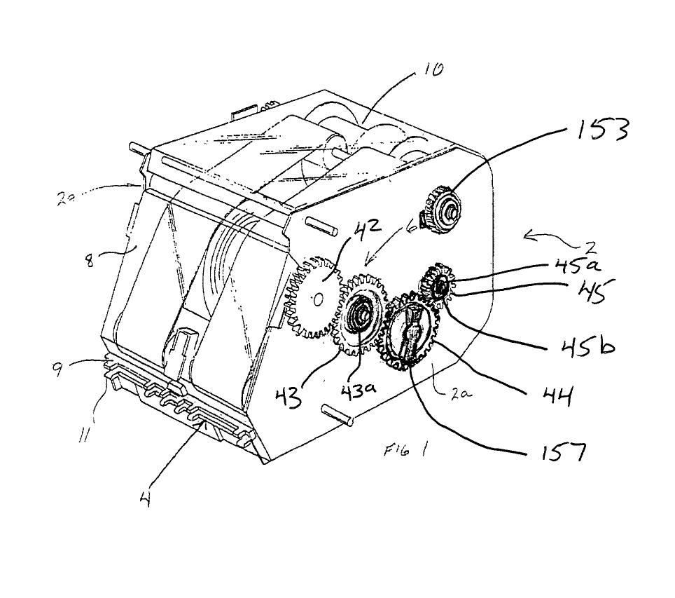

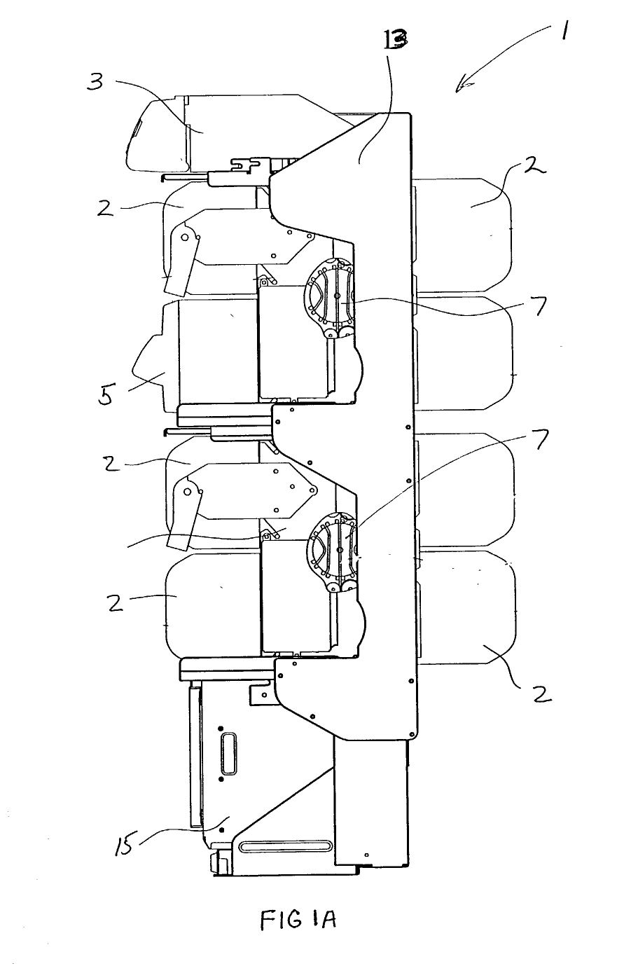

A financial transaction system 1 shown in FIG. 1A includes a frame 13 which releasably secures various components of the system. Banknotes are fed through the validator 3 and are discharged from the validator adjacent the rear thereof and moved along a discharge path. This discharge path is essentially vertical and passes through the rotary switches 7. Banknote accumulators 2 are selectively connected via the rotary switches 7 to the banknote discharge path. In this way, any received banknote can be fed to any of the accumulators to the banknote dispenser 5 and the banknote stacking cassette 15. Each of the accumulators 2 is releasably received in the frame 13 after the frame has been basically opened along the discharge path.

Banknotes, once authenticated by the validating head 3, can be selectively stored in any of the accumulators 2 and can be returned to the user through the dispenser 5 if the banknote is found to be rejected, and can be fed to the banknote cassette 15. Basically, the accumulators allow for recirculating of the banknotes whereas the banknote cassette 15 does not have the capability to return the banknote to the discharge path. Motor drives for each of the accumulators 2 are provided along side the discharge path. Banknotes can also be fed between accumulators.

Details of the accumulator 2 are shown in FIG. 1. Each accumulator has an enclosed housing defined by the non transparent side panels 2 and transparent portions defined by the hinged panel 8 and the fixed clear wrap panel 10 which extends around the accumulator and basically meets with the hinged panel 8. The clear panels 8 and 10 allow visual inspection of the interior of the accumulator and the working components thereof. Banknotes are fed to the accumulator through the banknote slot 4 and the accumulator is driven by the drive arrangement 6 to either draw a banknote into the accumulator or to dispense a previously received banknote from the accumulator. The banknote slot 4 is defined between the flanged end 9 of the hinged panel 8 and the flanged end 11 of the panel 10.

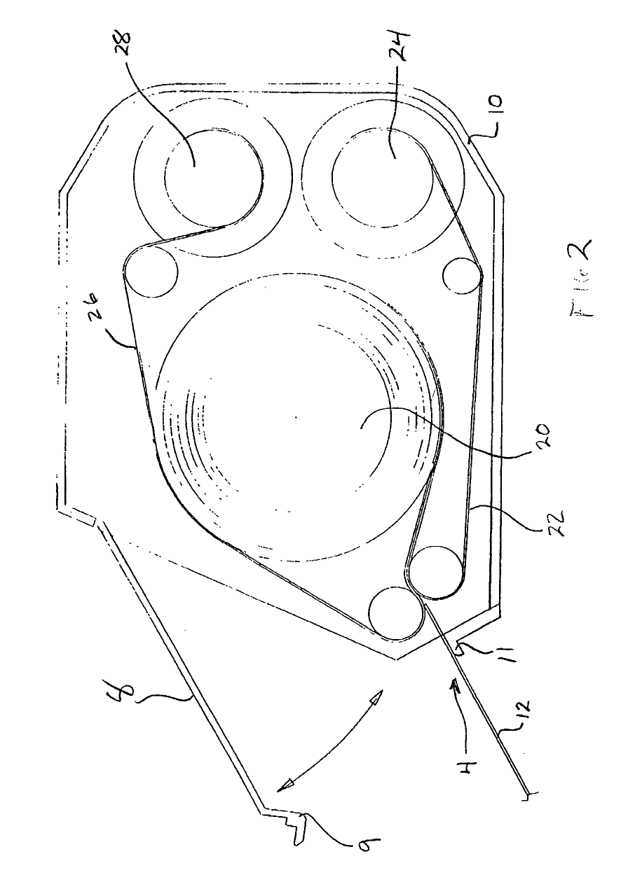

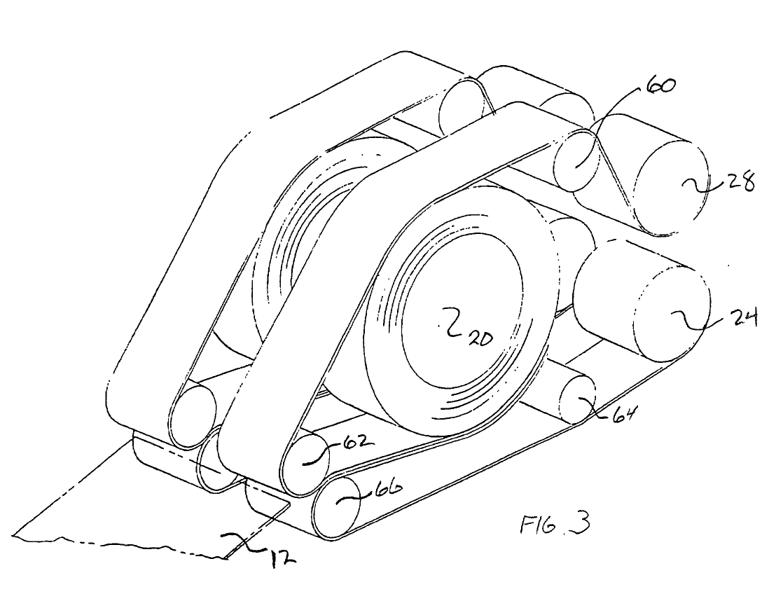

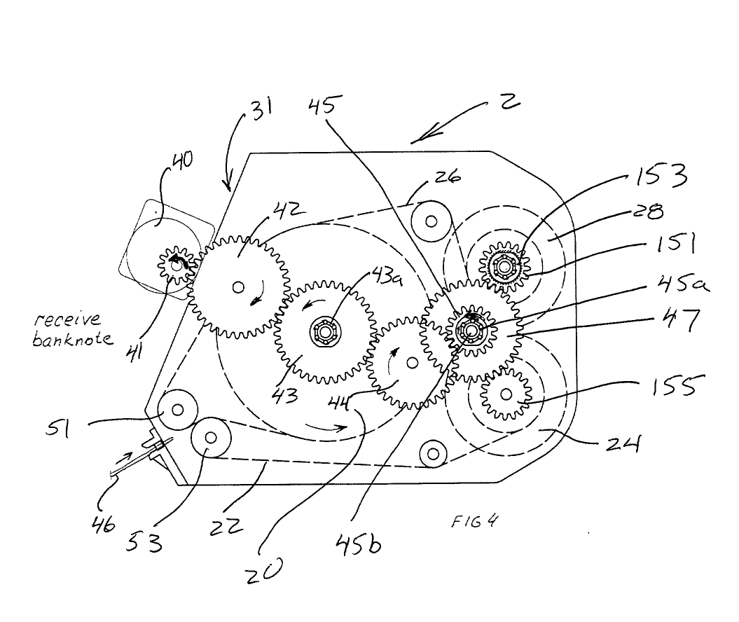

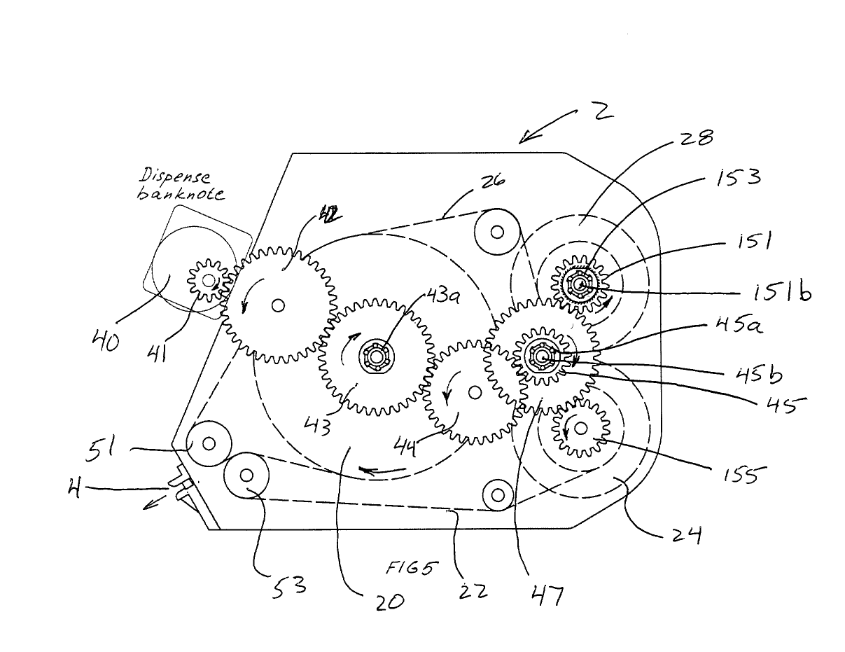

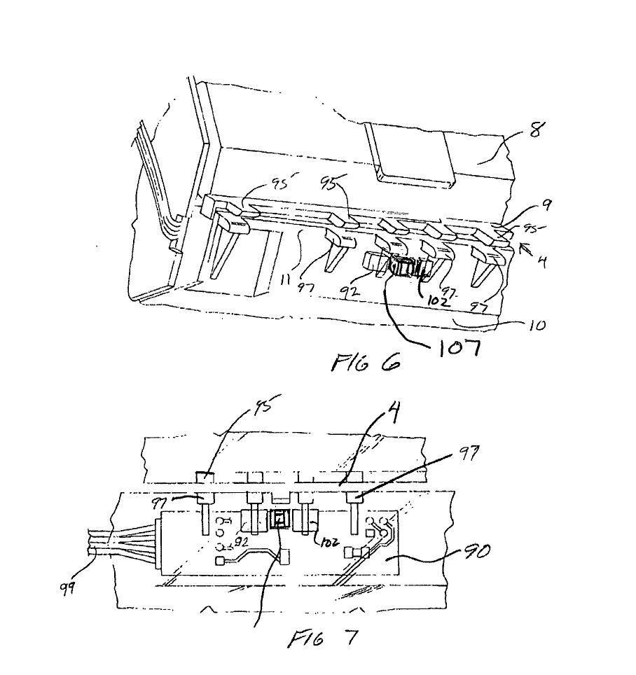

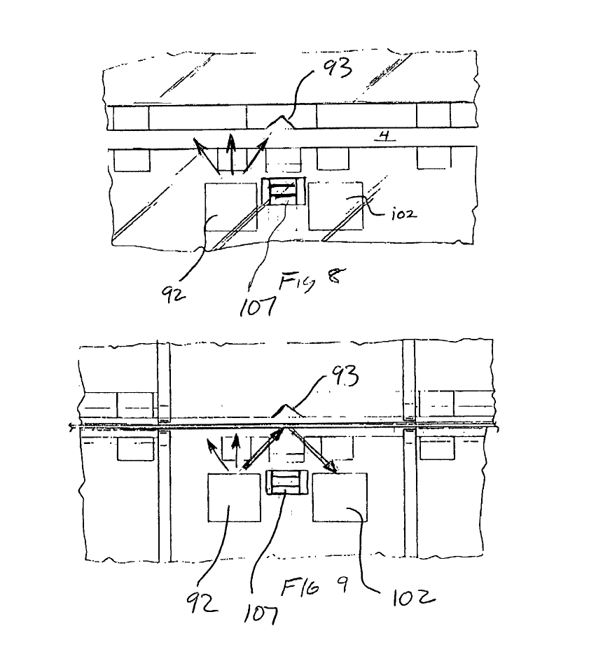

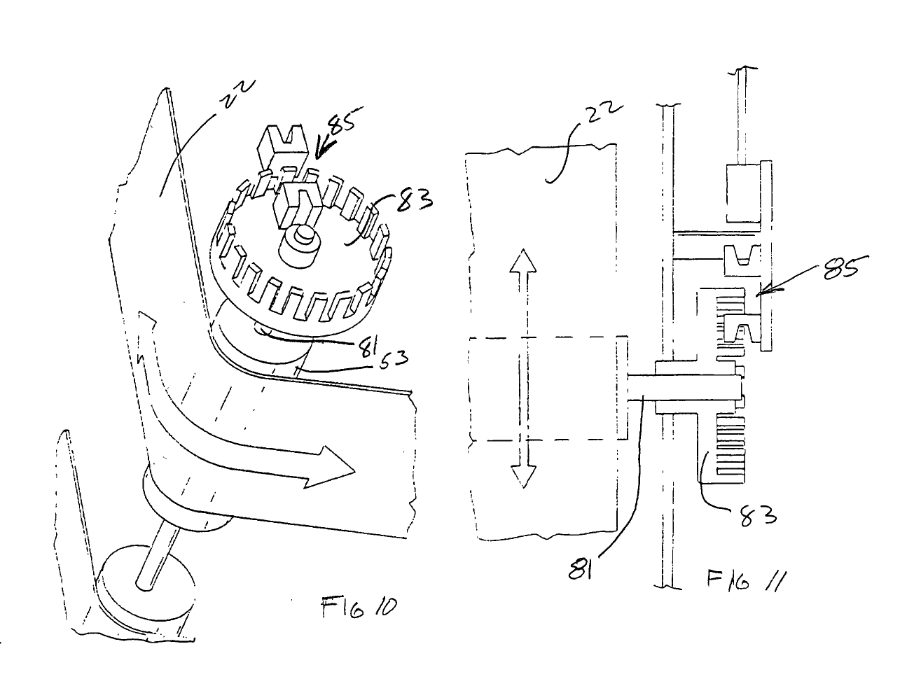

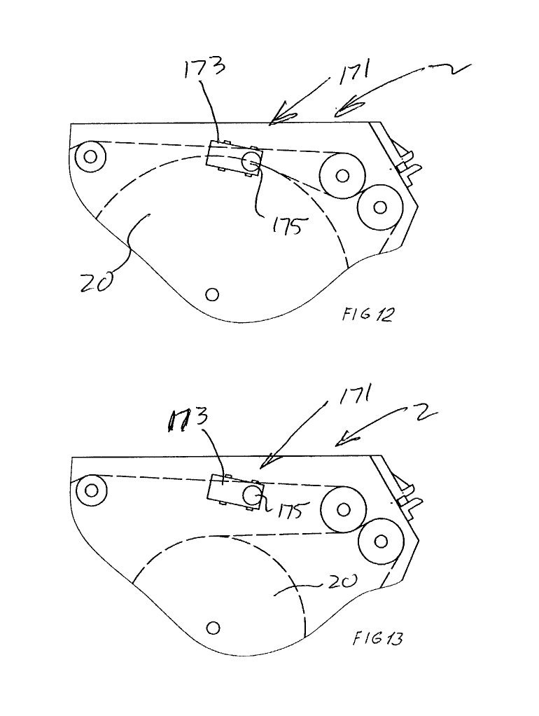

FIG. 2 and FIG. 3 illustrate the internal workings of the accumulator. A banknote 12 is being fed into the accumulator and wound on the drum 20. The accumulator has two tapes 22 which engage the lower surface of the banknote 12 and two tapes 26 which engage the upper surface of the banknote. As can be appreciated, these tapes and the banknote are then wound on the drum 20. Each of the tapes 22 has a tape reel 24 holding a certain length of tape and tapes 26 have supply reels 28. Each of the tapes 22 and 26 are secured to the drum 20 and are wound onto the drum when the drum is driven in a manner to receive banknotes. In this way, banknotes are serially wound on the drum 20 and are separated from previously received banknotes and later received banknotes by means of the tapes 22 and 26. These tapes also serve to control the banknote as it is being fed to the winding drum 20 and to control the banknote as it is being dispensed from the winding drum and guided out of the accumulator through a banknote slot.

FIG. 2 also shows how the hinged panel 8 can be released and pivoted outwardly to provide better access to the banknote feed point between the rollers 62 and 66. Each of the tapes 22 and 26 can have a number of guide rollers such as rollers 60 and 64 to provide guidance of the tape as it is wound onto the drum or as the tapes are wound onto the supply reels 24 or 28.

The accumulator 2 shown in FIG. 4 has a rearwardly angling wall 31 which provides space for connecting with the drive motor 40 which is part of the financial transaction device 1. Each of the accumulators is adapted to be releasably secured within the device and connect with a motor for driving of the accumulator by means of the drive train 6. As shown in FIG. 4, the motor 40 includes a drive gear 41 in mesh with gear 42 which in turn drives gear 43 connected to the winding drum 20 via an overrunning clutch 43a. Thus the winding drum 20 is controlled and driven by the motor 40 which is a reversible motor.

FIG. 4 shows the drive train rotating to receive the banknote 46. In this embodiment, the counter clockwise drive of the motor 40 and gear 41, is rotating gear 42 in a clockwise direction and is rotating gear 43 in a counterclockwise direction. Gear 43 has an over running clutch 43a which can overrun but only with respect to a clockwise rotation of gear 43. With the rotation shown in FIG. 4, gear 43 is rotating and is in mesh with gear 44 causing rotation thereof. Gear 44 is in mesh with gear 45 and is rotating gear 45.

The drive gear 45 is connected to the drive shaft 45b through a overrunning clutch 45a. As shown in FIG. 5 overrunning clutch 45a is engaged and drives shaft 45b when gear 45 is rotated in a clockwise direction. Gear 47 is fixed on shaft 45b and is on the opposite side of the accumulator. Gears 151 and 155 are also on the opposite side of the accumulator. When gear 45 is rotated counterclockwise all gears are being driven and supply reels 24 and 28 are rotated to wind the tapes during dispensing of a banknote.

During receipt of a banknote, as shown in FIG. 4, the winding drum 20 draws each of the tapes 22 and 26 from their supply reels. The supply reels can slip on their shafts due to a separate friction clutch arrangement associated with each reel. In this way a certain amount of tension is maintained on the tapes as they are being wound onto the winding drum 20. As can be appreciated, the actual speed of the tapes is determined by the motor 40 and the diameter of the accumulated tapes and banknotes wound on the winding drum 20. The mere withdrawing of the tapes with a friction drag simplifies the gearing arrangement for the accumulator.

During receiving of a banknote as shown in FIG. 4 the overrunning clutch 45a is allowing gear 45 to rotate counterclockwise while shaft 45b is stationary. Gear 47 is stationary. The overrunning clutch 153 is on the same side of the housing as gear 45 and is attached to the housing and to shaft 151b. The external body of the overrunning clutch is secured to the wall of the accumulator and the internal ring of the clutch is connected to shaft 151b. With this arrangement shaft 151b can rotate counterclockwise but is locked against clockwise rotation. This also serves to lock gear 47 against counterclockwise rotation and lock gear 155 against clockwise rotation.

Therefore during receipt of a banknote overrunning clutches 45a and 153 hold gears 151, 47 and 155 stationary. Gears 41, 42, 43, 44 and 45 are rotating as a function of the motor speed. Tapes 22 and 26 are being withdrawn as a function of the winding drum 20.

FIG. 5 shows the accumulator when driven in a manner to dispense a banknote previously wound onto the drum 20. Connected to gear 45 is gear 47 by means of the one way clutch 45a. Gear 47 drives gear 151 and 155 to wind the tapes. This is an overdrive relationship of the reels 24 and 28 that is acceptable due to the friction clutch of the reels with their respective shafts. This overdrive arrangement assures that regardless of the speed of the tapes as a banknotes is being dispensed, the drive arrangement will be sufficient to take up all of the tape and to provide a positive tension force thereon. When the diameter of banknotes and tapes on the drum decreases, the necessary drive of the tapes will be slower and therefore there will be more clutch slippage.

The tapes 22 and 26 guide the banknotes as they are being dispensed from the drums 20 and feed the banknote through the banknote slot 4. As can be seen, the guide rollers 51 and 53 are closely positioned adjacent the banknote slot 6 and a banknote will still be partially wound on the drum as it departs through the banknote slot 6. Thus control over the banknote is maintained during dispensing of a banknote as well as during receiving of a banknote.

The gears of the drive train 6 connecting motor 40 and the reels 24 and 28 are all rotating during dispensing of a banknote. One way clutch 153 is slipping allowing gear 151 to rotate the associated drive shaft.

The overrunning clutch 43a serves a different purpose. A handle 157 shown in FIG. 1 is used to rotate the gear train by hand when the accumulator is out of the financial transaction machine. During unloading of banknotes, the ends of the tapes are fixed to the reels and form an end stop position. Continued rotation of the drive train could break the tapes. The overrunning clutch 43a and 45a allow continued rotation of gear 44 on its own when this condition occurs thus protecting the accumulator from inadvertent damage.

It is desirable to coordinate the speed of the banknote as it is being fed to the accumulator 2 while it is still being driven in the discharge path associated with the financial transaction device 1. The motor 40 is separately controlled and is adjusted as a function of the sensed tape speed 22 or 26 to match the banknote feed speed.

To provide control of the motor 40, certain information is sensed by the accumulator. In particular, as shown in FIGS. 6 through 9, the transparent panel 8 and the transparent panel 10 at the flanges 9 and 11, cooperate to allow sensing of the leading and trailing edge of a banknote as it is received or dispensed from the accumulator. The transparent panels are particularly helpful for problem solving when operating difficulties are encountered. It can be recognized that although these transparent panels are preferred non transparent panels can be used. The transparent panels when transparent can have built in lenses for the light transmitter and receiver.

As shown in FIG. 7, a circuit board 90 is secured interior to the accumulator and is attached to the transparent panel 10. The processing board includes an optical output 92 that generates and directs a beam of light 101 into the banknote path. If a banknote is present some of this light is reflected off the banknote surface and is received by the optical receiver 102. If there is no banknote the light is transmitted across the channel and will strike the angled notch 93. This notch in the hinged panel 8 serves to prevent direct reflection of the light from the hinged panel 8 to the optical receiver 102. Thus if a banknote is not present no appreciable light is received by the optical receiver.

A banknote motion sensor 107 is located between the optical transmitter 92 and the optical receiver 102. This motion sensor senses the leading and trailing edges of the banknote as they pass the sensor as well as movement of the banknote past the sensor. Preferably this sensor is an air pressure sensing type as disclosed in our co-pending U.S. application Ser. No. 10/191,465 entitled Motion Sensor for Flat Objects filed Jul. 10, 2002 which is incorporated herein by reference. This sensor is on one side of the banknote path and senses air turbulence associated with the movement of the banknote through the banknote channel.

Associated with the flanges 9 and 11 are a number of projecting tabs 95 and 97 which assist in transferring the banknote from the rotary switch to the accumulator or from the accumulator to the rotary switch. The circuit board 90 also includes an electrical connector 99 which provides power to the circuit board and also allows the transmission of signals from the processor board to the transaction device 1. Also associated with the processing board 90 is a further optical generator and receiver where the light emitted by the transmitter strikes one of the tapes 22. As shown in FIG. 14, tape 22 includes an end portion 23 having substantially different light reflecting properties. In particular, it is preferred that this portion of the tape be black and the remaining portion of the tape be highly reflective. The portion of the tape that is black is of a length greater than a banknote and as such, the accumulator can sense that the tape is almost at its maximum length. Light which has previously been reflecting off the tape 22 is basically scattered by the black portion or more or less absorbed by the black portion 23 such that the accumulator knows that the tape is approaching the end position. In this way the accumulator will advise the transaction device and no further banknotes will be received by the accumulator until certain banknotes have been dispensed therefrom.

FIGS. 10 and 11 illustrate a speed arrangement for sensing of the speed of the tape 22 and 24 as it passes over the idler roller 53. The idler roller 53 is firmly connected to the shaft 81 and causes rotation of the speed sensing wheel 83. As can be seen, the wheel 83 has a slotted peripheral edge and a light receiver transmitter arrangement 85 is associated with the slotted edge. The projections on the wheel interrupt a light beam between the light sensing arrangement and causes a pause with each movement of the wheel 83 causing the projections to interrupt the same. This provides a fine incremental signal used to measure the speed of the tape 22. This signal is then processed and the motor 40 is coordinated to effectively match the speed of the tape with the feed in the banknote drive passageway. Basically the banknote is being fed to the accumulator at a more or less predetermined speed and the motor 40 is adjusted to make sure that the accumulator receives the banknote at the appropriate speed. The motor 40 is driven in a stop/start manner and is basically started as a banknote enters the banknote slot for causing an interruption of the light beam. The motor quickly brings the accumulator to speed of the banknote as it is being received.

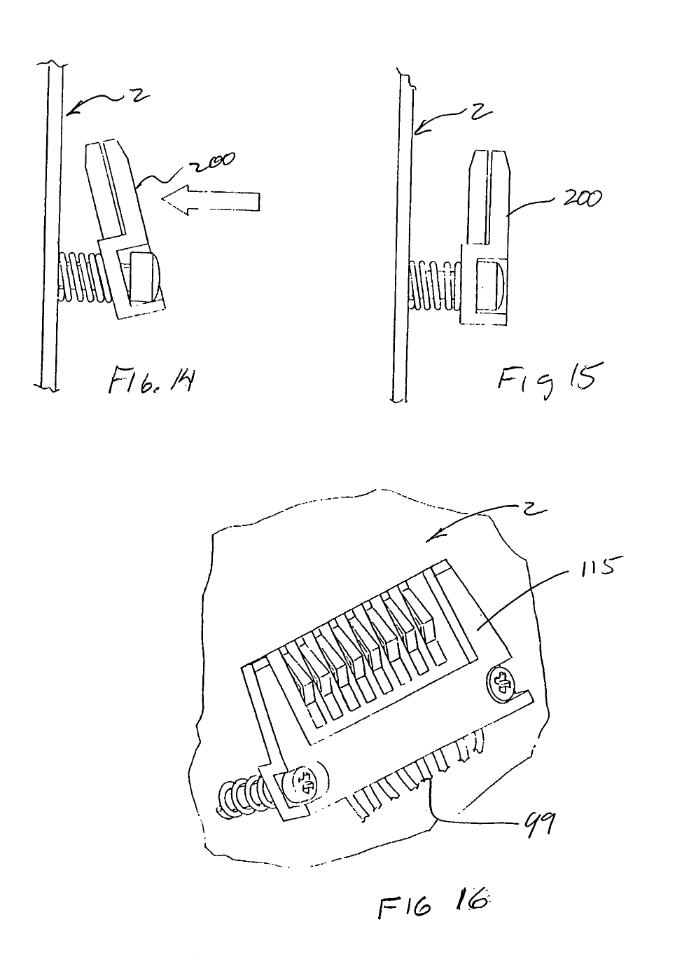

Furthermore, this speed arrangement is also used to bring the banknote to the appropriate speed for receipt in the passageway. The signals from the speed sensor are appropriately processed either by circuit board 90 or are fed to the financial transaction device over a wire connection 99 associated with the accumulator. The accumulator includes a side mount spring loaded connector 115 shown in FIGS. 15 through 17 for connection with a similar type receiver connector associated with the transaction device. This spring loaded connector allows interaction of the two components to effect the desired electrical connection. The spring loading allows for some movement of the connector that may be necessary for proper alignment. It also provides a spring biased electrical connection. The various signals from the accumulator are now coordinated with the control signals of the financial transaction device to achieve the desired synchronization.

FIGS. 12 and 13 show a sensing arrangement 171 for determining when the accumulator is essential full and should not receive any more banknotes. A light transmitter 173 generates a beam of light which is directed across the accumulator. The beam of light leaves through the lens 175 of the light transmitter 173. In FIG. 12 the banknotes which have been wound on the winding drum 20 cause an increase in the diameter and eventually will interrupt the beam of light.

The beam of light in FIG. 12 has now been interrupted by the banknotes stored on the winding drum 20. A light receiver is positioned on the opposite side of the accumulator and receives the beam of light when the stored banknotes do not interrupt the beam as shown in FIG. 13. This provides a simple arrangement for detecting a full condition of the accumulator.

The sensing arrangement of FIGS. 12 and 13 provide a simple arrangement for sensing a full condition of the accumulator due to the space required to accommodate the banknotes wound on the winding drum. This sensing arrangement is preferred as a mere count of received banknotes may not accurately determine the space requirements and the sensing arrangement is operative regardless what thickness of banknotes is being accumulated. As can be appreciated there can be variances between currencies and even within currencies. It is preferred that the accumulator be generic and therefore the sensing of the accumulated banknotes is preferred to a counting arrangement.

As can be appreciated from the above description, the banknote accumulator 2 receives banknotes for later dispensing and allows effective dispensing of banknotes to the financial transaction device. The banknote accumulator senses various properties of the banknotes as they are being received by the accumulator or dispensed from the accumulator such than an accurate count is maintained. The circuit board 90 also includes its own memory device to provide information regarding the state of the accumulator when it is removed from a financial transaction device and to also record any movement of the device once it has been connected. A small power supply is also provided to power the sensors and measure any movement. This information can be helpful in the event there is a discrepancy between the number of banknotes in the accumulator when a technician initially removes it from the device and what was later provided to the owner. The transparent housing allows any service personnel to basically inspect the accumulator and immediately identify problems associated with the last received banknotes. This can be very helpful to confirm problems alleged by a user. As can be appreciated some users will misrepresent the facts in an attempt for personal gain. The transparent housing when the accumulator is removed can be viewed by all parties and reduces disagreements.

The hinged panel 8 which can be opened as indicated in FIG. 2 by means of operating the latch 79 allows for quick correction and perhaps reinstallation of the accumulator and the transaction device. It also allows for convenient access from time to time to the interior components and particularly the pairs of tapes 22 and 24.

Although various preferred embodiments of the present invention have been described herein in detail, it will be appreciated by those skilled in the art, that variations may be made thereto without departing from the spirit of the invention or the scope of the appended claims.

The embodiments of the invention in which an exclusive property or privilege is claimed are defined as follows:

1. A banknote accumulator comprising a housing having a banknote slot through which banknotes are received, a winding drum within said housing and rotatably drivable for winding of banknotes thereon, guide tapes attached to said winding drum and forming a transition for guiding a banknote onto or off of said winding drum and through said banknote slot, a drive arrangement for rotatably driving said winding drum in a banknote receiving direction to wind a banknote and said tapes about said winding drum and rotatably driving said winding drum in a banknote dispensing direction to dispense a last received banknote on said winding drum with said tapes guiding said last received banknote from the winding drum through said banknote slot, said drive arrangement additional driving said guide tapes to accumulate said guide tapes as the tapes are unwound from said winding drum during dispensing of the last to be received banknote, and wherein said housing has at least one transparent observation panel sized to allow visual inspection of said winding drum and said guide tapes through said housing.

2. A banknote accumulator as claimed in claim 1 wherein said housing includes end panels and side panels, and wherein said side panels are transparent.

3. A banknote accumulator as claimed in claim 1 wherein said housing includes built in optical elements which guide light from an optical transmitter and assist in directing light reflected from a banknote to an optical receiver where said optical transmitter and said optical receiver are on one side of said banknote slot.

4. A banknote accumulator as claimed in claim 1 wherein said housing is rearwardly angled adjacent said banknote slot forming a wedged shaped housing configuration centered on said banknote slot.

5. A banknote accumulator as claimed in claim 1 including a speed sensing arrangement for measuring banknote receiving and banknote dispensing speed.

6. A banknote accumulator as claimed in claim 5 wherein said speed sensing arrangement measures tape speed adjacent said banknote slot.

7. A banknote accumulator as claimed in claim 1 including an electrical signal processing arrangement and an electrical signal arrangement through which operational information of the accumulator is transmitted.

8. A banknote accumulator as claimed in claim 7 wherein said electrical signal arrangement includes a channel for providing a power feed to said accumulator.

9. A banknote accumulator as claimed in claim 8 wherein said accumulator includes a self contained power supply and memory means for recording of sensed changes to said accumulator after removal from a financial transaction device.

10. A banknote accumulator as claimed in claim 1 wherein said housing has a releasable panel movable from a closed position defining an operating configuration of said housing to an open service position providing access to the interior of said housing.

11. A banknote accumulator as claimed in claim 10 wherein said movable panel is pivotally attached to said housing and pivots during movement thereof between said closed position and said open service position.

12. A banknote accumulator as claimed in claim 11 wherein said movable panel and said housing include a latch arrangement for latching said panel to said housing in said closed position.

13. A banknote accumulator comprising a housing having a banknote slot through which banknotes are received, a winding drum within said housing and rotatably drivable for winding of banknotes thereon, guide tapes attached to said winding drum and forming a transition for guiding a banknote onto or off of said winding drum and through said banknote slot, a drive arrangement for rotatably driving said winding drum in a banknote receiving direction to wind a banknote and said tapes about said winding drum and rotatably driving said winding drum in a banknote dispensing direction to dispense a last received banknote on said winding drum with said tapes guiding said last received banknote from the winding drum through said banknote slot, said drive arrangement additional driving said guide tapes to accumulate said guide tapes as the tapes are unwound from said winding drum during dispensing of the last to be received banknote, said accumulator including a plurality of electrical sensors which measure and detect operating conditions of said accumulator and an electrical signal processor for analyzing the signals of said sensors and communicating with a remote financial transaction processor through an electrical connection associated with said housing and through which power is provided to said accumulator.

14. A banknote accumulator as claimed in claim 13 including separate power means and memory means associated with said electrical signal processor for recording of changes to said accumulator when power is not provided thereto through said electrical connection.

15. A banknote accumulator as claimed in claim 14 wherein said electrical connection is resiliently mounted to provide a spring bias for providing pressure electrical connection with a cooperating electrical component when in engagement therewith.

16. A banknote accumulator as claimed in claim 14 including electrical sensors for detecting a banknote in said banknote slot and the speed of the banknote in said banknote slot.

17. A banknote accumulator as claimed in claim 16 wherein said electrical signal processor transmits speed information of a banknote being received or being dispensed through said electrical connection used to externally adjust the speed of said drive arrangement.

18. A banknote accumulator as claimed in claim 17 wherein said housing includes a transparent panel for viewing the contents of the accumulator

19. A banknote accumulator as claimed in claim 18 wherein said transparent panel forms part of a light sensor used to detect the presence of a banknote in said banknote slot.

20. A banknote accumulator as claimed in claim 18 wherein said transparent panel is hingedly attached to said accumulator and is movable between a closed position allowing viewing of components interior to said housing and an open position providing access to components interior to said housing.
